(19) United States
(12) Patent Application Publication
(10) Pub. No.: US 2009/0067421 A1
(43) Pub. Date: Mar. 12, 2009

(54) Method and device for transferring digital information

(75) Inventor: Bill Linden, Upssala (SE)

Correspondence Address: YOUNG & THOMPSON, 209 Madison Street, Suite 500, ALEXANDRIA, VA, 22314, US

(73) Assignees: BILL LINDEN, UPPSALA (SE); EKONOMI & JURIDIK LARS WALDENSTROM, LIDING (SE)

(21) Appl. No.: 11/919,882

(22) PCT Filed: May 4, 2006
(86) PCT No.: PCT/SE2006/000538

§ 371 Date: Dec. 27, 2007

(30) Foreign Application Priority Data
May 4, 2005 (SE) 0501014-5

(51) Int. Cl. H04L 12/56

(52) U.S. Cl. 370/389

(57) ABSTRACT

A device and method for transmitting digital information, where the Transmission takes place from an information-providing entity (71) to a final destination entity (81). It is significant that the digital information to be sent from the first data communication device (70) to the second data communication device (80) is divided into at least two information sections (30-34), that every information section (30-34) is transmitted from the first data communication device (70) to the second data communication device (80) via a separate Transmission (20-24), that Transmissions (20-24) take place in the form of simplex communication, and that the information in the information sections (30-34) is put together in the second data communication device (80) for receipt of the information coming from the information-providing entity (71).

### TECHNICAL FIELD OF THE INVENTION

The present invention relates to a method and a device for the transfer of digital information.

In all types of digital communication, plain text and the transfer of it are protected in different ways and at different levels of technology, against both Transmission errors and illegal eavesdropping.

These levels are called “layers” and exist from the deepest binary layer up to encryption and plain text. In the Internet, as well as in mobile communication networks and radio traffic, there are a greater number of such security layers than within the fixed telephone network using copper or fiber optic lines. The area of the invention is “security layers in all forms of communication with protection of the encryption itself, which is in turn protected against illegal eavesdropping during the transfer of digital information.”

### PRIOR ART

Today, the transfer of information occurs for one transmitting device to one receiving device via one linked connection based on two unique IP numbers that constitute the respective party's digital identity for the connection. The connection is thus a two-way communication (duplex) over a single line. The contents is often but not always encrypted. This is handled by the transmitting party and occurs in order to prevent unauthorized eavesdropping, which is absolutely possible during ongoing Transmission. Essential parts of the communication take place via the Internet, even if fixed or dedicated telephone lines are used to a great extent within nations. Yet ever more Transmissions of sensitive information do take place via the Internet, since private direct lines with special equipment are expensive to install and maintain and rent from telecom operators; there is also the disadvantage that fixed lines are tied to one and the same physical location, thus limiting the user's mobility (e.g. 3G telephony). Data Transmission via the Internet already comprises at least 90% of Transmission needs, and is constantly increasing.

Currently, encryption usually occurs via automatic programs installed by default in the transmitting device. Yet during Transmission itself, the line used is totally vulnerable to eavesdropping. Anybody with the right scanning equipment thus has access to all the encrypted information, which can then be interpreted at length at another location.

Transfers between the transmitting/receiving “device” (see definitions below) are today protected against unauthorized eavesdropping via various forms of what is referred to as encryption, which is accomplished (among other methods) by secretly agreeing in advance on what is referred to as a “key” to be used in interpreting the Transmission. A message is scrambled to the point of unrecognizability in the transmitting device, and is then sent out to the recipient computer via the Internet. “Decryption is only a matter of time” is a well-known saying. This means that decryption stands in direct relation to the total processing power at the disposal of the unauthorized party for the purpose of revealing the encryption key that was used. The great resources required for decryption are owned by organized criminal elements driven by both financial and ideological considerations. These criminal organizations are constantly luring scientists and expert hackers into their ranks, and present a great threat to today's ever more globalized world order. Today, these organizations have access to computer programs that can control (“kidnapping” or “hijacking”) our home computers without our knowledge, link them into discreet networks, thus creating a global network of millions of PCs at our expense, each of which performs its small share of the enormous calculations required to crack the encryption key, which would take a single, powerful computer hundreds of years to do. Naturally, we do not know how scientifically advanced these groups are, but there are strong indications that we should not underestimate the matter.

In addition to the veritable avalanche of Internet criminality—which reaches new levels of scientific sophistication every six months—we know

a) that no encryption key in history has successfully avoided unauthorized decryption,

b) that the gap between, on the one hand, the known leaks and opportunities for identity theft, and actual cases of identity theft on the other, is inexplicably large, which may mean that the criminal organizations can already now interpret encrypted data Transmissions,

c) that banks are experiencing a negative loss that nobody is able to explain,

d) that the criminal organizations have successively managed to crack 16-bit, 32-bit and 64-bit encryptions, as well as 128-bit wireless encryption,

e) that in February 2005, a Chinese research team managed to shake the encryption universe by powerfully reducing the number of possible variants of encryption's most fundamental element—the so-called SHA-1 protocol--which was thought previously to be able to withstand the criminal decryption onslaught until 2010,

f) that the Swedish State's Telecom Authority, The Postal and Telecom Supervisory Board, PTS, etc., deem that encryption “does not provide a security guarantee.”

The actors affected today by the risk of losing their identity and/or other sensitive information in the course of data Transmission via the Internet, and whom will be protected by the invention include:

1) Private persons shopping online who enter their bank card number and pin code and provide other information upon remote check-out in order to verify their identity.

2) Private persons who send account information to their Internet bank when making payments.

3) Transfers between banks and other financial institutions.

4) Government bodies and other authorities requiring privacy.

5) Police, customs and tax authorities, as well as courts.

6) Universities and research and development centers.

7) Hospitals and insurance companies.

8) Private companies.

9 Military organizations.

10) Certain mobile phone users.

11) Also the very large group of users who, due to carelessness or ignorance, do not use encryption technology when transferring Information via the Internet, which includes all e-mail communication.

### The Strategic Error in Internet Security Thinking

Encryption technology has become a complicated science with huge costs. Every time it is revealed that an encryption method has been cracked, steps are taken to advance only the encryption by another step. There is a constant game of cat and mouse between encryption experts on both sides of the law. Nothing other than protection by means of encryption is ever discussed. Thus, there is a lack of imagination that has prevented the insight from dawning, that what is required is an entirely new way of thinking about security, with new technical weapons. Merely expanding encryption technology is not enough. It must both be expanded and also be protected unto itself. Aside from this invention, today there is no available technology that protects the encryption itself.

To counter the criminal resources by only expanding encryption technology itself, which is what is happening today, is akin to fitting an unguarded door with bigger and bigger locks, which anybody is free to try to pick, without anyone trying to stop them. Every time the lock is switched out, the criminals buy a better picklock, then an even bigger lock is bought, and so on. This cannot go on much longer; something entirely new and other than “a bigger lock” has to happen.

### TCP/IP and UDP

Every device that can be connected to and communicate via the Internet must have a unique address, such that the programs that utilize the Internet's functionality can identify the person in question as a unique participant in the communications that are to be able to take place to and from this address. This address is called an IP (Internet Protocol) number.

The following is a simple popular-technical description of a complicated multi-level scheme, such that we do not get bogged down in descriptions of technology for which no patent is being sought, though without departing from correctness.

When data is sent via the Internet, it basically takes place in one of two ways when performed by civilians: TCP/IP (Transmission Control Protocol/Internet Protocol), or UDP (User Datagram Protocol). With regard to the limitations and features of the technology, these two are nearly each other's opposite. All data communication takes place through what are called ports. Every IP number has tens of thousands of ports to choose from.

TCP/IP, on the one hand, makes it possible to send a Original message/data packet to anyone with an IP number. This occurs in the same way as a regular telephone call, i.e. in that the transmitting party's (i.e. the “caller's”) apparatus sends out a request to the closest server “switch” in the chain to be established, in order to see, in part, whether it exists, and also whether it has the capacity and a line in order to receive the coming Transmission and reroute it to a final recipient in accordance with an “address label.” If the receiving server does not exist, another line to another server is chosen (redundancy). The existing and future intermediary recipient server provides an answer to this request in the form of a Yes or a No. This procedure is this based on two-way communication (duplex), which in turn requires that the sender has a generally known port that is always open in order to receive the answer. In order for a data Transmission to be able to reach its final destination, there are accessibility requirements the entire way from the sender to the final destination.

TCP/IP is a necessary method in a world of global communication where everyone is supposed to be freely able to communicate with everyone, regardless of whether the recipient was known to the sender in the past. The communication group within TCP/IP is therefore not a predefined group of communicators. You do not know which or how many servers will participate in the process. With TCP/IP, none of the “intermediaries” involved, nor the final recipient, know which packets the Transmission consists of, or how many there are. The consequence is that if, as according to the invention, one transmits/splits in batches, i.e. the original messages are divided up from the beginning and move in different ways from an original sender to a final recipient, then every part of the Transmission within TCP/IP must be given a flag (digital fraternity with the other Transmissions), such that the final recipient knows which Transmissions belong together by only reading an unencrypted external flag on these, so as to recognize their digital fraternity. This flag cannot be encrypted, since otherwise it would be impossible for a recipient to be able to differentiate between different Transmissions/batches and how these are to be decrypted. Once the recipient of the flags has seen which Transmissions belong together, the equipment reads the open key, “public key”, included in the Transmission for decryption. With TCP/IP then, every Transmission/batch has to be equipped with such an encryption key, since the sender (of an e-mail, for instance) cannot send a message to someone unknown to him without at the same time giving the recipient access to a tool for decrypting the message, since it is impossible to come to a totally unique agreement for all Internet users globally in advance. The most common way to use TCP/IP is also to resend the original message (verification) back the same way to all the servers involved, so that the original sender can see that the entire message has arrived.

TCP/IP implies several large security risks.

In part, the duplex method requires that every transmitting server in the process have a port open in anticipation of answers to requests and verification, implying vulnerability to the ever more sophisticated virus programs in circulation, which can then make their way into the central entity.

The batched Transmissions must in this case be provided with digital fraternity, which can be noted just as easily by criminal eavesdroppers.

Public keys are required, which provide great assistance to hackers in decryption.

Verification then always takes place along the same route back, which is helpful to eavesdroppers, since this allows them to know that the Transmission contains the entire Original Message.

Verification by the return of the entire message is of invaluable help to decryption efforts, since hackers know that the entire public key can be found in what was copied.

Before the advanced virus programs entered the Internet forum, and decrypting messages would have taken 700 years, there was no reason to refrain from the TCP/IP method, which provides advantages in the form of unlimited data transfer to unknown recipients without prior agreements having been reached.

Today, software viruses have completely changed the situation. The invention therefore uses UDP. (see FIG. 3b). The functions listed below differ from TCP/IP. In all of the cases listed below, agreements in the form of private keys are reached completely in advance between the physical users of Transformer 70, 80 and the other servers participating in the communication and their users. These private keys are thus not information that are transferred digitally in any way, and can therefore not be used in any way for unauthorized decryption of a wiretap or otherwise. The recipient thus KNOWS WHAT may be on the way, HOW it is expected to arrive, and in what CONDITION it will come.

This means that the invention unconditionally requires predefinitions for all the transmitting and receiving devices and transformers included in the communication group. The unconditional requirement of predefinition on the one hand has the negative consequence that it limits the number of digital devices that can be involved simultaneously to the highest predefined number of the same for each instance (i.e. you cannot transmit wherever you want just like that, but can only transmit to a closed group of users “predefined group”), yet on the other hand this requirement has the positive consequence that the communication process is able to use UDP, thus enabling the invention and its extreme enhancement of security compared to the security of Transmissions using TCP/IP.

### OBJECTS AND FEATURES OF THE INVENTION

A primary object of the present invention is to create a well-organized, yet randomly exposed chaos by spreading the client identity very widely.

With reference to the metaphor presented above with regard to prior art, i.e. the one involving locks on an unguarded door, the invention for its part might be compared to designing the ways leading to the door and its big lock in such a confusing way that nobody can even find the door, much less the lock (encryption). One simply has no idea of where to look. The invention is thus an “overarching security layer” and constitutes the needed paradigm shift within Internet security, and has the potential to become the new global standard. Since the invention first and foremost protects against access, and thus protects the encryption of the sensitive total content as well, the invention can be considered to be of patentable inventiveness and utilization.

At least the primary object of the present invention is realized by means of a method and a device that have been given the characteristic features of the appending independent patent claims. Preferred embodiments of the invention are defined in the dependent patent claims.

### DESCRIPTION OF THE PRINCIPLES OF THE INVENTION

The invention relates to a method in the form of a new so-called security layer, which protects the Transmission of information itself against unauthorized eavesdropping and thus protects both encrypted and unencrypted information in Transmissions. The invention thus protects the encryption itself, since all the information, and thus the possibility of decryption, is spread out among more than one transfer in what hereinafter is referred to as the Transmission (see Definitions).

The invention's security layer lies above all other similar layers that may be present in the transfer of information, without thereby affecting the function of any underlying security layers.

The invention uses simplex communication, i.e. one-way communication. This means that a potential eavesdropper only sees data Transmission in one direction and thus has no use of the verification that normally takes place immediately afterwards, sometimes using the same information that was already transmitted. The method allows for the use of a great number of IP numbers, which is different from customary data transfer.

There are two main media to be used in digital information Transmission.

A. Internet

B. Other communication media, such as wire, fiber optics, or wireless.

The invention can even be applied as a combination of A and B.

Below, the invention will be introduced for use over the Internet (A), and clarified using one of the many embodiments covered by the invention. In this case, the example will be Transmission of the total customer identity from the swiping of a bank card at a store register, “till”, which is then distributed via an exposed, encrypted Internet connection to the financial institution for an account checkout.

The identity in the original information packet to be transferred is divided into mass Transmissions of the “fan” type, from randomly selected Transmitting devices to randomly selected Receiving devices. In addition to this well-organized chaos, certain of the Transmissions are somewhat delayed, such that parallel Transmissions (other bank card queries, etc., e.g. from other store registers/tills) will be transferred simultaneously with the original query in order to mislead eavesdroppers into thinking that the simultaneous Transmissions are part of the same query. This actively adds to the difficulty of analyzing the whole picture. Within every Transmission, the customer identity (account number, name, pin code, etc.) is stored in Transmission sections (see Definitions) containing both true and false information, as well as false decryption keys.

If extremely high security is desired, the recipient's subsequent verification and Transmission other information in turn occurs in like fashion in new, chaotically generated Transmissions, though this time to completely different Receiving devices than those that originally transmitted, which further comprises any attempt to eavesdrop. Furthermore, the original identity, etc., that was originally transmitted will not be returned. Unauthorized eavesdroppers can thus never gain any information from a Transmission, regardless of the direction, that could help them crack any encryption key. The returned Transmission however, is not as large as the one that was originally transmitted (due to the false information with which it was seeded), which further misleads eavesdroppers.

Once out on the Internet, in this invention there is no digital fraternity between the joint Transmissions, meaning that they cannot be deduced to be related to each other in the roar of transmitted data.

The effect is that the eavesdropping party will never be able to access the entire contents of the message, since he cannot know in advance:

from where the Transmissions are being made,

to which recipient points they are directed,

what the individual Transmissions contain,

what is the total message contents if the Transmissions contain data from the same provider of information or identities are mixed,

which encryption codes are alternatingly used

when the Transmissions occur,

nor what the verification back to the sender is actually verifying, since it looks similar but is completely different.

In order to make an unauthorized presence during the Transmissions even more difficult, these take place according to a Hash function—an accepted mathematical table method whose number combinations cannot be calculated. The parties to the Transmission have agreed, either from the beginning or on an ongoing basis, on certain information to be used in the Transmissions. The receiving party has knowledge from the beginning regarding how many points the Transmissions will amount to, though not when, where, or how. For instance, of 20 Receiving devices, potentially only 5 will be used in a randomized fashion. The recipient's Transformer, however, finally assembles all the Transmissions and their Transmission sections into a single unit of information that the Receiving Transformer is able to understand, in accordance with a protocol established in advance. Irrelevant Transmissions and irrelevant Transmission sections in given Transmissions/Batches are filtered out, leaving a total message that contains all the essential data, which is then processed in the customary way.

The invention eliminates all forms of pin codes and passwords that have to be remembered, and which can be illegally scanned, leading to the need for their replacement. Pin codes and passwords are a serious issue that Microsoft® and other leading companies in Internet security have deemed by now. Lacking better security, pin codes and passwords will continue to be used by most banks after 2007, according to industry announcements, making the invention even more useful, furthermore utility and technical effect.

The invention has the advantage that the user may himself decide on a security level by increasing both the number of transmitting/receiving points and the number of broadband operators, or by changing his own physical Transmission location by means of indirect Transmissions through his own branch offices and other offices, further compromising attempts to reassemble the original Information package. It is thus possible for a transmitting party to transmit his “fan” of Transmissions from different locations, cities and countries, to a single location where the receiving party has all his receiving points, and vice versa, i.e. transmitting from a single location to a recipient whose receiving devices are spread across many locations; combinations thereof are also possible.

The invention (FIG. 5a) makes conditions absurd for an unauthorized eavesdropper in comparison with today's practice of transmitting everything in a single string over a single line, and also returning verification on the same line (FIG. 1a).

### BRIEF DESCRIPTION OF THE DRAWINGS

Below, a preferred embodiment of a device in accordance with the present invention will be described with reference to the attached drawings, where:

FIG. 1a shows a transfer, in accordance with prior art, of a customer's identity, e.g. over the Internet, with a potential eavesdropper 100 and his connection 101;

FIG. 1b shows a Transmission divided into two Transmissions 20, 22 in accordance with the TCP/IP method, with requests, flags and public keys;

FIG. 2a schematically displays the components included in the present invention, along with the various communication media that the device uses;

FIG. 2b schematically displays a situation in which a customer swipes a bank card at a store register/till 71. An Information packet is transferred to a Transformer 70, where processing takes place before Transmission via, e.g., the Internet 90;

FIG. 3a schematically displays how the information packet's data is processed in the Transformer 70 for Transmissions 20-24 and their encrypted Information sections 30-34. Every Transmission is assigned a Destination;

FIG. 3b schematically displays how Transmission occurs via Transmitting devices 10-14, which is/are connected to its/their own broadband 65. The Transmission batch is distributed unprocessed directly via the communication medium (the Internet) 90 to Receiving device 40-44 connected to its own broadband 66. Receiving devices 40-44 distribute the Transmissions, unprocessed, to the Transformer 80;

FIG. 3c schematically displays how the Transmissions 20-24 and their encrypted Information sections 30-34 are processed in the Transformer 80. False information is sorted out, and the Agreed protocol is compared. All information pertaining to this Information packet is assembled into plain text;

FIG. 4a schematically displays how the Transformer 80 distributes plain text to the Final destination/Account control 81;

FIG. 4b schematically displays return response/verification. The Final destination 81 transmits a return response to the Transformer 80;

FIG. 5a schematically displays how data is processed in the Transformer 80 in a way similar to that shown above in FIG. 2b.

FIG. 5b schematically displays how the Transformer 80 processes the data in the new Information packet into Transmissions 50-54 and Information sections 60-64, which are distributed via Transmitting devices 40-44 for return Transmission e.g. via the Internet. The data is received in Receiving devices 10-14, which distribute the return information via Receiving devices 10-14, without processing the data, to the Transformer 70; and

FIG. 5c schematically displays how data is processed in the Transformer 70, as well as the weeding out of false information and analysis. The plain text information packet is distributed to the Information provider/store register 71.

### Definitions and Flow of Transmission

An Information packet may be: A bank account number, pin code, identity number, social security number, sum to be paid, store code, transaction code, etc. for stores that have bank card terminals at the till.

In other cases, an Information packet may be: a document, name, telephone number, meeting locations, map material, drawings, mathematical formulae, medical records, police reports, other customs and police information, government directives, military documents, internal company information, research material, various types of private information, etc.

The Information packet is derived from Information provider 71 or 81.

Information provider 71 or 81 may be physical or digital. Digital information providers may exist in the form of automatic databases or in other forms. Physical persons may be store customers—whose identities are vulnerable when they pass through a medium where eavesdropping is possible—or other persons with different preferences for keeping information secret. In this document however, only a store customer 71 is considered, along with his customer identity distributed over the Internet for remote bank card verification 81.

The Final destination 81 in this application of the invention consists of a bank card company, bank, etc. Credit checkout control of a bank card swiped at a store register/till.

Data processors/Transformers 70 for the Store end and 80 for the checkout end consist of a computer or other comparable data communication device, whose task is to assemble all information received from Receiving devices, as well as process and distribute it. All data processing occurs in Transformer 70 or 80.

Transmitting/Receiving devices 10-14 and 40-44, participating in Transmission 20-24 or 50-54. There is no upper limit to the number of Transmitting/Receiving devices involved in a single Transmission or Receipt. The lower limit is two Transmitting/Receiving devices, which handle two Transmissions/Receipts. The drawings show five (5) Transmitting/Receiving devices connected to each Transformer 70 or 80.

The term “Transmitting/Receiving device” refers to one of the following: a computer, a server, a specially designed piece of hardware with software for data communication, a 3G-4G, etc., mobile telephone for mobile Internet, a virtual dataport with an IP number assigned (normally there are 4 IP numbers for a commercial broadband connection) or a port under an IP number. (There are over 68,000 ports for each IP number. Every port can communicate independently over the Internet).

A Transmitting/Receiving device normally does not need to perform any processing of the information that it transmits or receives.

Earmarking refers to flagging the randomly chosen Transmitting/Receiving devices (selected by Transformer 70 or 80 within the reserved maximum number of receiving devices that are provided at a given point in time), which are intended to receive a certain quantity of information defined by Transformer 70 or 80 (“a Transmission”).

Transmission occurs in the form of individual Transmission instances (batches), yet Transmissions (20, 21, 22, 23, 24, . . . , etc., or 50, 51, 52, 53, 54, etc.) in this document are referred to collectively as Transmissions 20-24 or 50-54, representing all Transmissions participating in the transfer of a certain Original Message from 71 or 81. A Transmission can be compared to an envelope being mailed.

Within a specific Transmission 20-24 or 50-54, the Information packet from 71 or 81 is divided into Information sections (30, 31, 32, 33, 34, etc., or 60, 61, 62, 63, 64, etc.) in the Transformer 70 by a method planned out in advance and agreed on with the Transmitting/Receiving devices; in this document these sections are referred to as Information sections 30-34 or 60-64, where each Information section comprises its own delimited portion of information from the Information packet, without there being any digital fraternity or other connection between the Information sections over the period of time and space between Transformers 70 and 80, and vice versa. An information section may be compared to a section of a message found in the mailed envelope/Transmission.

The Transmitting/Receiving devices 10-14 and 40-44 may be located next to each other in an internal network (Intranet) 67 or in physical locations (remote from one another) in a remote network (Extranet) 68 and 69. In this document, they are referred to collectively as Networks.

Encryption. The distortion of data contents to the point of unrecognizability, based on codes or “keys” agreed to by the transmitting and receiving parties in advance, which are needed in order to decrypt the information into plain text. Encryption is prior art, and is not included as a function in the invention.

Hash table and Hash function. A highly advanced technology whereby a message is coded according to a certain table agreed to in advance by the sending and receiving parties. Text with a hash function requires a lot of processing power to be converted by to plain text. Hash functions are prior art and are not included as a function of the invention.

Randomization. Random selection.

Simultaneous. At the same time.

Standby. Passive waiting mode.

Verification. A return reply to the sender that the original message has been received in a correct way and in the correct amount.

IP Number=Internet Protocol. The identity given to every device involved in data communication by the master server.

Xz, KX, ?Y, ??, ??? (..), (...) refers to false and misleading information in the figures.

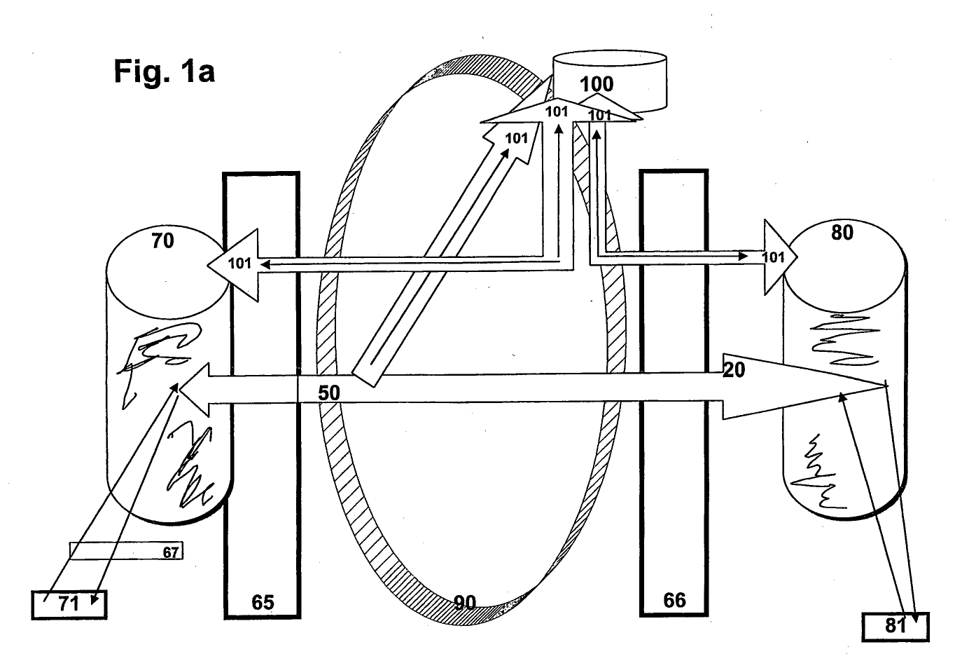

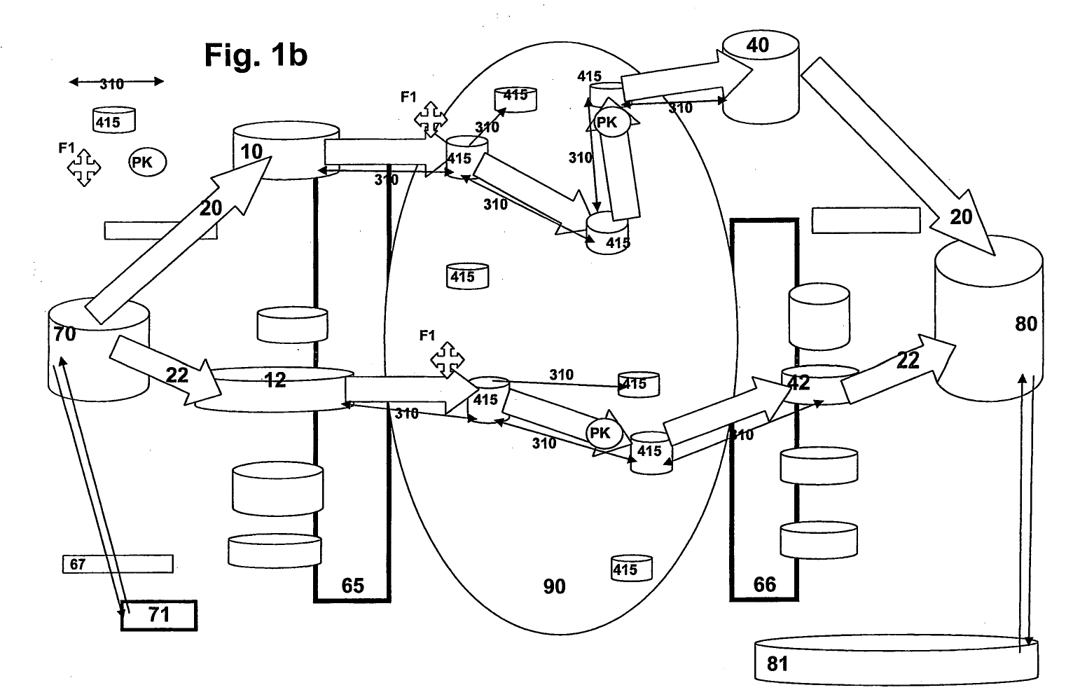

### DESCRIPTION OF PRIOR TCP/IP ART IN FIGS. 1a AND 1b

FIG. 1a shows the customary procedure for transferring a complete original message via a single path 20 on a single occasion, and a return response/verification 50 back the same way, with no change made to the Original message received at 80.

FIG. 1b shows what data transfer split into batches (Transmission 20 and 22) of an Original message from Transformer 70 via Transmitting/Receiving device 10 and 12 to the final destination Transformer 80 via the Receiving devices 40 and 42 would look like according to the invention, in the event that the common TCP/IP method were used instead of UDP, as described in the invention.

Thus, the return arrows 310 become necessary requests in TCP/IP (query regarding accessibility).

The designation 415 refers to the intermediary servers out on the Internet that are unknown to the Transmitting device.

The designation F1 refers to a readily readable flag that indicates fraternity between two Transmissions 20 and 22 from the Original message.

The designation PK refers to the fully visible public keys to be used for decryption. FIG. 1b shows the vulnerability of the TCP/IP method.

### DESCRIPTION OF THE INVENTION

The invention comprises an entire Information packet sent by an Information provider 71 to a Transformer 70, consisting of a computer or the like, where the Information packet is processed in the Transformer and sent on via Transmitting/Receiving devices 10-14 in the form of multiple randomized Transmissions that are staggered and sent in batches to the Transmitting/Receiving devices 40-44, whose receiving function is not specified in advance for a certain Transmission 20-24, where the Earmarking (indication of intended destination) to the specific Transmitting/Receiving device 40-44 among a number of such Transmitting/Receiving devices 40-44 defined in advance, has been randomized by Transformer 70 and where the Earmarking is known only to the parties to the Transmission.

The invention includes a method whereby the receiving Transformer 80 is to identify the origin of Transmissions 20-24 associated with a certain original Information packet from 71, despite the randomization, interspersed with entirely different information packets.

The invention includes the ability to differentiate genuine Information sections 30-34 from false ones, for further delivery in plain text.

The invention includes the ability to perform all these steps in the opposite direction for verification and return response.

The invention includes the ability of both the transfer and receipt of data to take place from any location inside or outside the user's own network. Thus, some of the Transmissions can take place simultaneously to Receiving devices in different countries, which are later reassembled at a single location in a Transformer 80 or 70, which is in turn found in an entirely unexpected location.

The invention also includes a method whereby Transmissions are delayed. Transmitting/receiving devices 10-14 and 40-44 can be controlled by Transformer 70 or 80 such that Transmissions 20-24 or 50-54 are made simultaneously or in staggered fashion. If delay/staggering occurs, only certain parts of the original information are sent, along with parts of an entirely different piece of information which is then given precedence so that “it looks like” the Transmissions that were just sent were really associated with each other, further frustrating unauthorized analysis. This is particularly appropriate in larger stores with long cashier lines, where bank cards are used all the time, whereby the parts of the information will be transmitted in irregular combinations.

The invention also includes the ability of the user to independently decide on the number of Transmissions 20-24 or 50-54 to be used by means of a simple tool, as well as on the number of Information sections 30-34 or 60-64, i.e. the security level one desires for information exchange at any given time. The more Transmissions 20-24 or 50-54 there are per individual Information packet, the higher the security level of the invention. There is no upper limit to the number of Transmissions 20-24 or 50-54, not for the number of Information sections 30-34 or 60-64. The lower limit is two. This ability to be able to decide on a security level for each data Transmission occasion without prior expertise is unique, and answers a large need. This will be utilized by many.

The method of the invention makes it impossible for unauthorized eavesdroppers to know in advance
where the Transmissions will suddenly come from,
and when,
which broadband operators have been chosen for each individual occasion,
via which locality or via which country the Transmissions 20-24 or 50-54 are distributed,
where they are destined,
in what way they will arrive (wire, wireless, Internet, fiber optics),
what order they will arrive in,

or to be able to determine after the fact in the criminal analysis laboratory
which information is genuine and which false,
or which part of the Transmissions 20-24 or 50-54 are associated with one or the other Information packet,
which Hash table has been used and
which encryption keys, whether genuine or false, were used in the event that many such were used in Transmissions 20-24 & 50-54.

Current methods are all based on a nearly identical procedure. A Transmitting device in close connection to the Internet handles both encryption and the Transmission of the information. The Transmission occurs in a single instance across a single connection to a single recipient, which is also in close connection to the Internet. This means that every potential eavesdropper today has the opportunity to copy all the details or the whole of the data transfer occasion, in order to be able to decrypt it later at length in his own laboratory, just by connecting to a single Internet connection of a certain type, and scanning all traffic that passes. The decryption scientists working for criminal organizations obtain loads of useful identities daily and discretely in this way, at no risk to themselves. Identity theft is also the fastest growing crime in the U.S.A. There is no technological protection. The costs already amount to many billions annually, and the frequency of such identity theft is growing hugely.

The method of the invention provides such technological protection by creating a well-organized and fan-shaped Transmission and receiving chaos, involving a mixture of encrypted genuine and false information according to a hash function, performed using multiple sudden and unexpected connections over distances great and small, both in the Original Transmission and in the return reply, making it impossible to sort out for anyone other than the authorized party. In that data processing does not occur closest to the connection points at the transmitting or receiving end, security is considerably enhanced with regard to viral infiltration of Transformers 70 or 80 through their natural firewalls. Since the randomized Transmission can occur to randomized recipients who do not recognize the Transmissions in advance (yet understand them when they arrive), there is no technical ability to plan an eavesdropping session in advance for anything but incomplete information. This is illustrated in the figures in that the eavesdropping criminal function 100 never gets complete information other than from an individual Transmission and a potential variation in the eavesdropping point is undertaken by mere chance, and is performed long after the Transmission took place between two points that will not necessarily be connected to each other again. The invention is made possible by a protocol agreed to by the parties in advance, which is modified from time to time.

By using UDP as the Transmission method, Transmissions 20-24 are transmitted without provoking the least interest, given that anyone intercepts them at all. The only thing of interest is how Transformer 80 verifies the receipt of the correct original method within the time criterion agreed to. Only the actual return response/verification is the response desired.

### Flow of the Invention

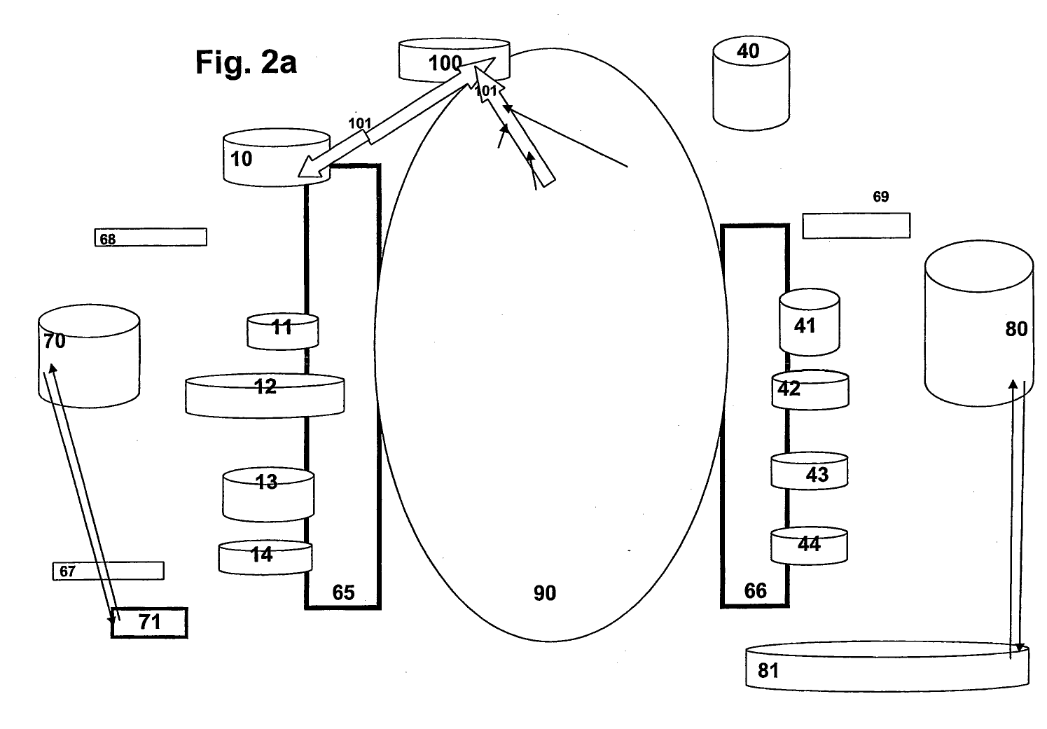

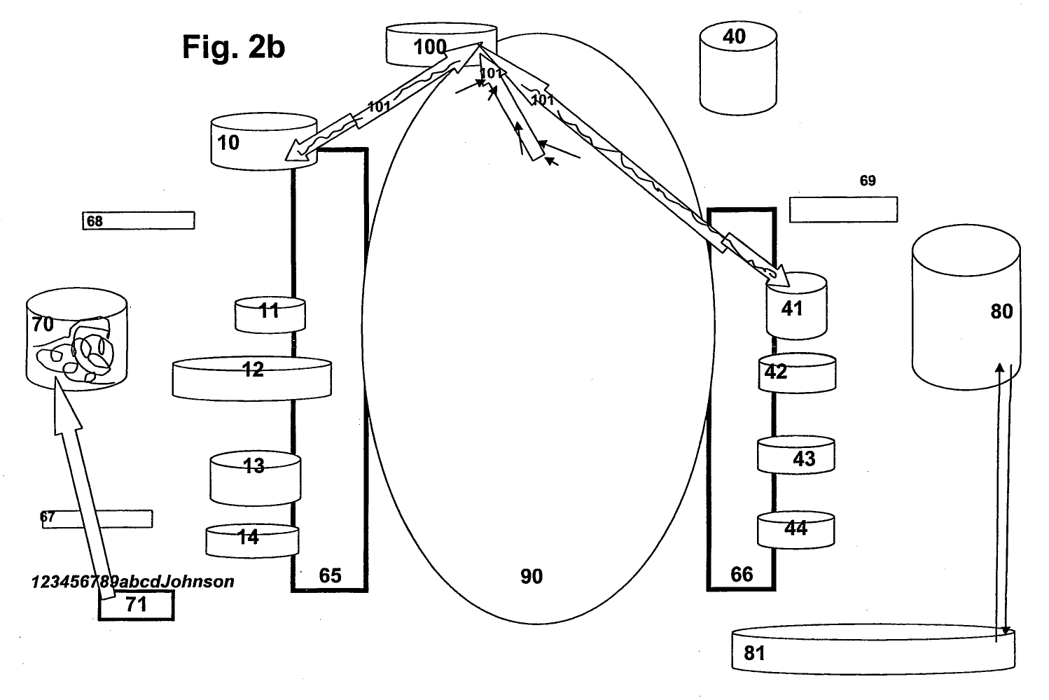

FIGS. 2a-2b. A Transformer 70 performs the functions listed below in connection with Transmissions 20-24.

Transmissions 20-24 are “fanned out” across the Internet Transmissions 20-24 either occur

simultaneously

or with a mutual time delay for the purpose of leaving room for items other than the Information/Query packet during the Transmission, so that other Information packets can be intermingled, further frustrating unauthorized analysis.

Unauthorized eavesdropping normally occurs at the point most commonly crossed by data traffic. This is shown for criminal eavesdropper 100, who is scanning Internet traffic and in certain cases spreads software virus 101, which according to the drawings loses its effect for Transmitting/Receiving devices 10-14, or 40-44, located closest to the communication medium 90 (such as the Internet or other internal network within a company or government office), thus also protecting Transformers 70 and 80 against direct data infringement.

1) FIG. 2a schematically illustrated receipt, for instance, of a bank card query, including other customer identity information in an Information packet in plain text, distributed via a Network 67 from the information provider, e.g. a store register/till or bank card terminal 71, to a Transformer 70, where the data of the Information packet is processed.

2) Processing of the data of the information packet implies that it is split into Transmissions 20-24, which do not exhibit digital fraternity amongst each other. Each Transmission 20-24 contains Information section/s 30-34.

3) Inclusion of false/misleading Information section modules 30-34.

4) Encoding of Information sections 30-34 in accordance with a Hash table.

5) Encryption of Information sections 30-34.

6) The temporal succession of Transmissions 20-24 from the Transformer 70 to the Transmitting/Receiving devices 10-14, and from these to the Transmitting/Receiving devices 40-44, is randomized and time-staggered, where the staggering does not have to be coordinated in advance with the recipient side's Transformer when it accepts whatever happens to come in; only later does it sort through the data and edits it in accordance with the agreed protocol.

7) Earmarking (designation of destination) of Transmissions 20-24 to selected Transmitting/Receiving devices 10-14 and 40-44, which need not have been coordinated with the recipient side in advance.

8) Randomization of the individual Transmissions 20-24 with regard to the Transmitting/Receiving devices 40, in accordance with a protocol.

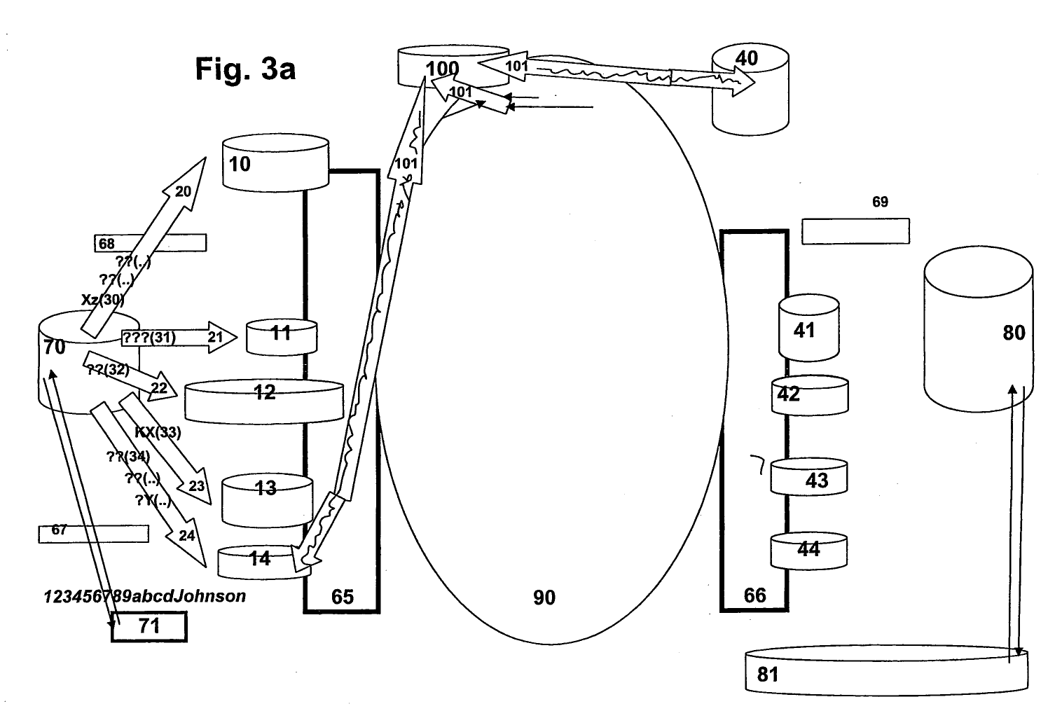

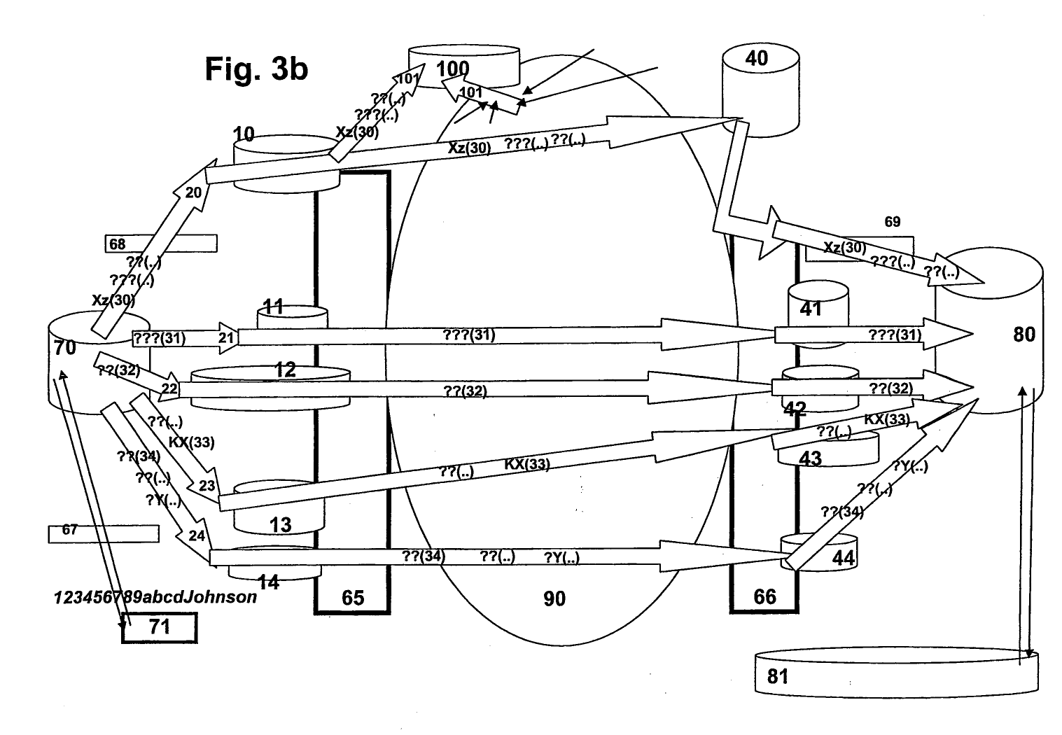

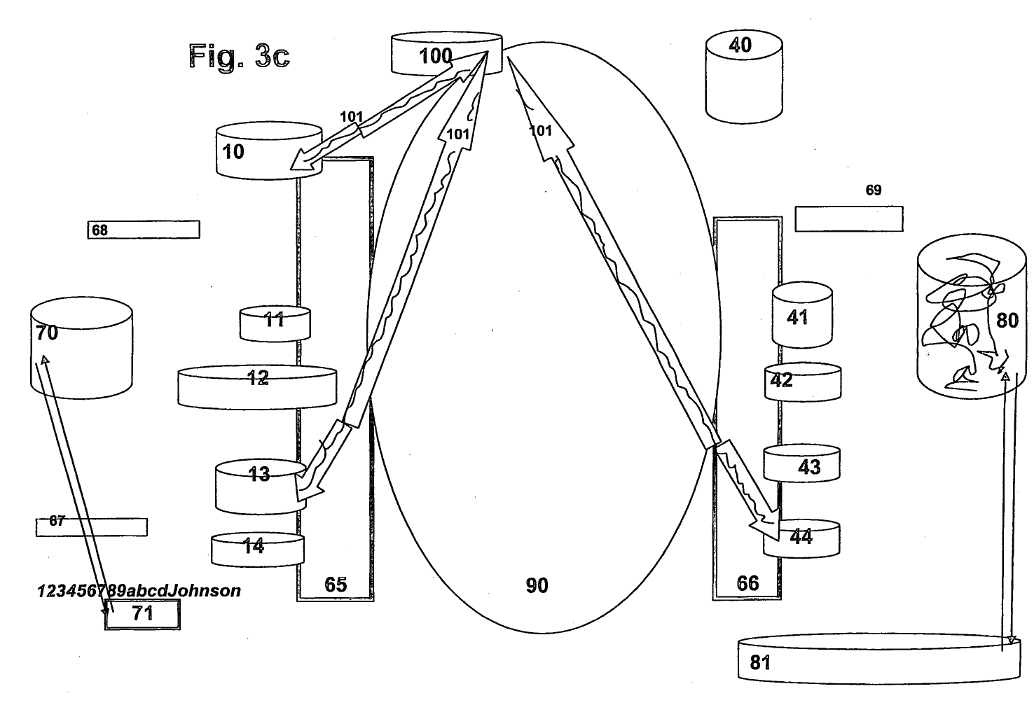

FIGS. 3a-3b Transmitting/Receiving devices 10-14 and 40-44 perform the functions listed below in connection with Transmissions 20-24.

1) Transmitting/Receiving devices 10-14 establish a connection in accordance with the random protocol, meaning that they accept Transmissions 20-24 from the Transformer 70.

2) Transmitting/receiving devices 10-14 deliver Transmissions 20-24 to the selected, Earmarked and waiting Transmitting/Receiving devices 40-44.

3) Transmitting/Receiving devices 40-44 accept Transmissions 20-24 from Transmitting/Receiving devices 10-14.

4) Transmitting/Receiving devices 40-44 forward all of the received Transmissions 20-24 from the Transmitting/Receiving devices 10-14 to the Transformer 80, without prior data processing.

5) Standby

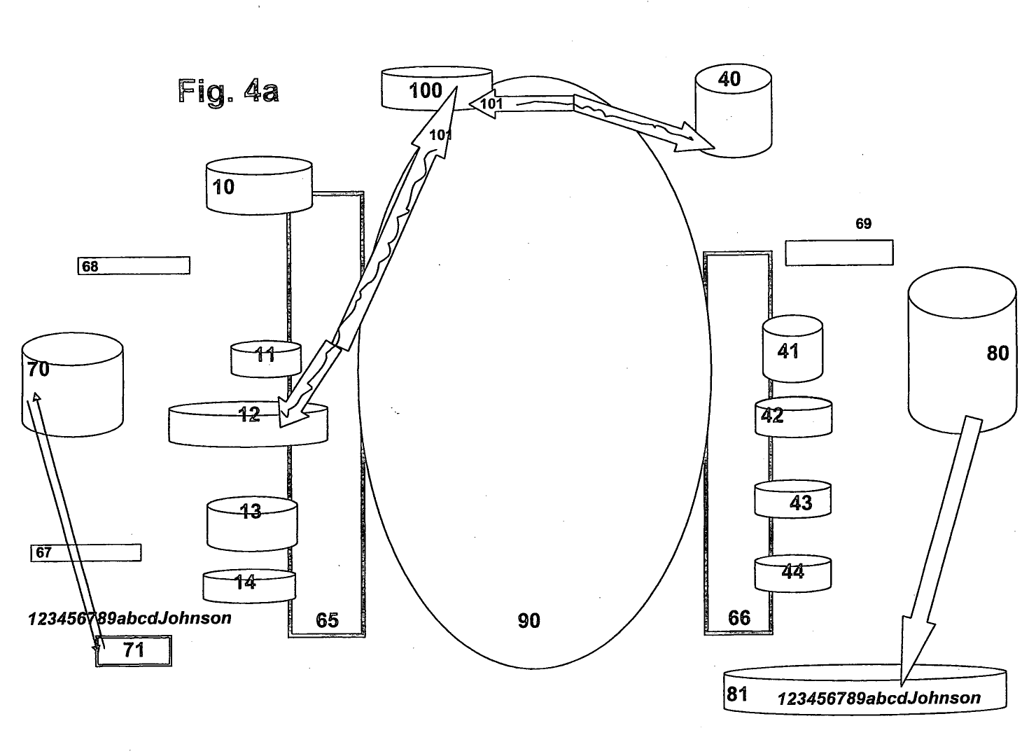

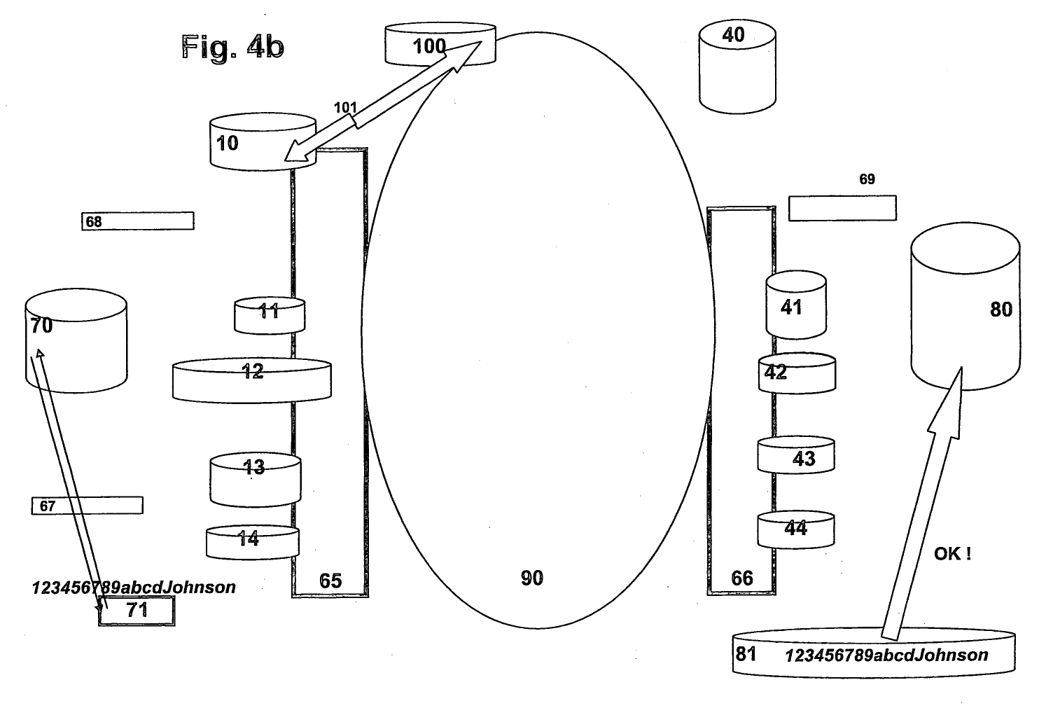

FIGS. 3b-3c and 4a. Transformer 80 executes the functions indicated below in connection with the receipt of Transmissions 20-24 from the Transmitting/Receiving devices 40-44.

1) Assembly of Transmissions 20-24 received from the Transmitting/Receiving devices 40-44.

2) Check performed according to a Hash table. If it matches in the table, the flow continues. (Hash functions are prior art and are not included as a function of the invention)

3) If there is no correspondence in the Hash table, the sequence is disconnected and the return reply “Rejected” as well as an error code are sent to the Information provider. (The cancellation of the transaction and error code generation are generally accepted commercial practice and are not included in the invention).

4) Analysis of Information sections 30-34 in Transmissions 20-24.

5) Deletion of false/misleading Information sections or parts thereof.

6) Assembly of the genuine Information sections 30-34 into the original Information packet.

7) Decoding/decryption into plain text (this step is a generally accepted commercial practice and is not included in the invention).

8) Forwarding of relevant query information in plain text to the Final destination 81, in this case to a bank card company, bank, etc. (This step is a generally accepted commercial practice and is not included in the invention).

9) Standby (This step is a generally accepted commercial practice and is not included in the invention).

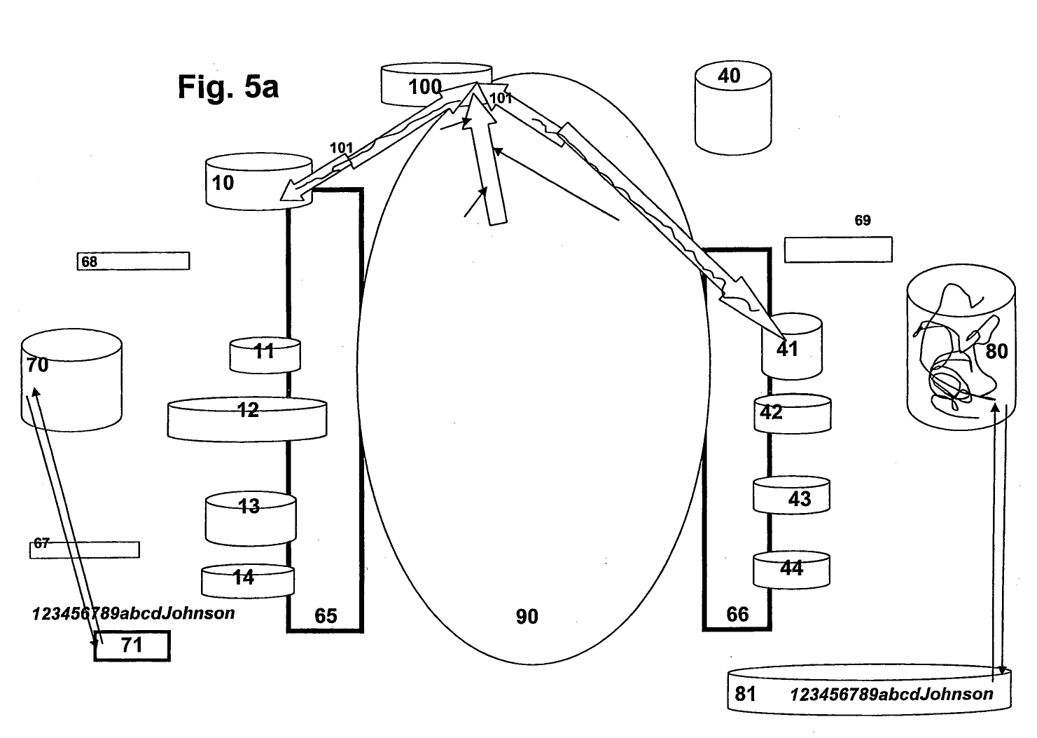

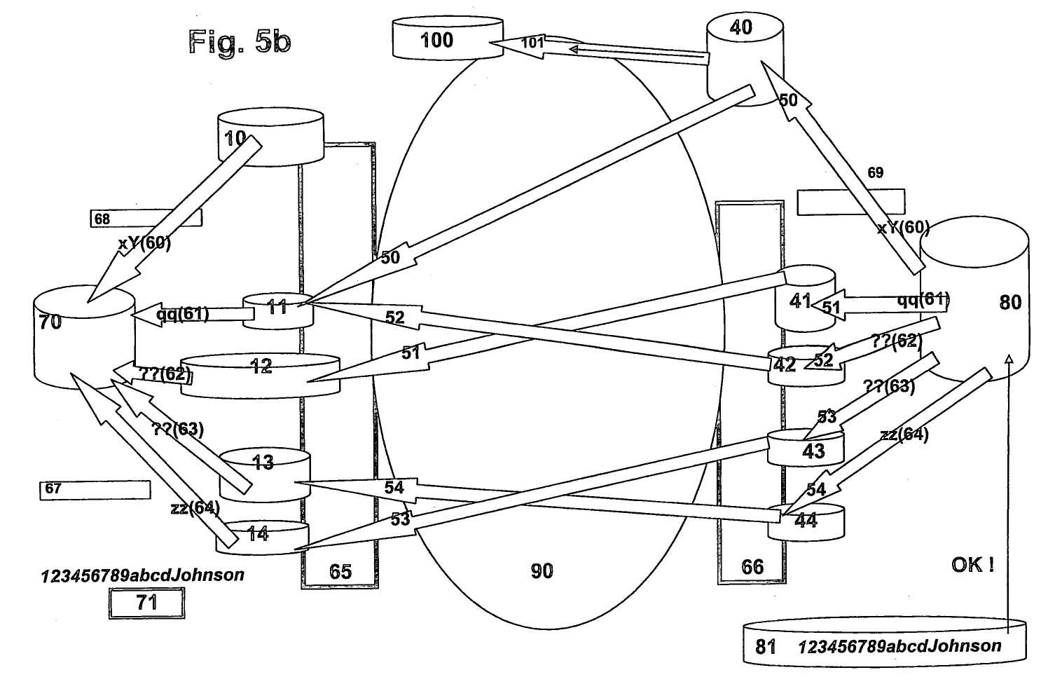

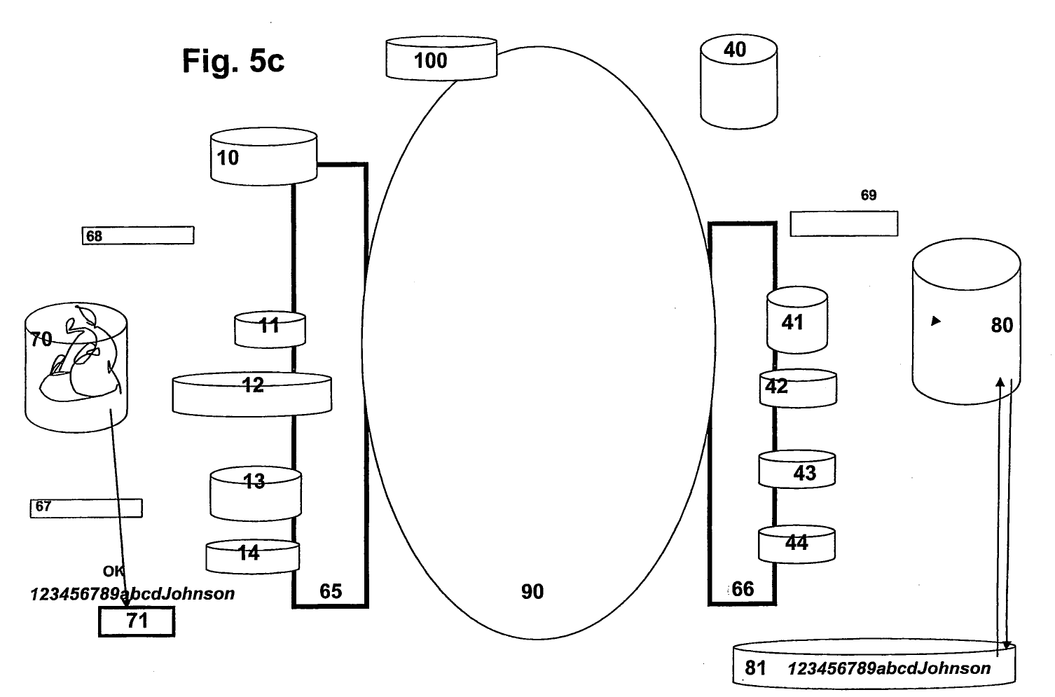

FIGS. 4b and 5a-5b. The Transformer 80 performs the functions listed below in connection with the Transmission of the return reply from the Final destination/Verification 81.

1) Receipt of response to the query from the Final destination/Check 81 (This step is a generally accepted commercial practice and is not included in the invention).

2) Processing of response so that it can be split into Information sections 60-64 before return Transmission.

3) Interspersal of false/misleading sections in Information sections 60-64.

4) Coding according to a hash table (Hash functions are prior art and are not included as a function in the invention).

5) Encryption (This step is a generally accepted commercial practice and is not included in the invention).

6) Splitting of Information sections 60-64 into Transmissions 50-54.

7) Earmarking of Transmissions 50-54 to the Transmitting/Receiving devices 10-14, which are now selected for receiving, but were previously transmitting.

8) Randomization of Transmitting/Receiving devices 40-44 with regard to the likewise randomized Transmitting/Receiving devices 10-14.

9) Transmission.

10) Standby (This step is a generally accepted commercial practice and is not included in the invention).

FIGS. 5b-5c. Transmitting/Receiving devices 40-44 perform the functions indicated below in connection with the task of transmitting information is response

1) Transmitting/Receiving devices 40-44 establish connections to Transmitting/Receiving devices 10-14 in accordance with the random protocol.

2) Transmitting/Receiving devices 40-44 deliver Transmissions 50-54 with Information sections 60-64 to the Transmitting/Receiving devices 10-14.

3) Standby (This step is a generally accepted commercial practice and is not included in the invention).

FIGS. 5b-5c. Transmitting/Receiving devices 10-14 and the Transformer 70 perform the functions listed below in connection with the task of receiving information in return

1) The Transmitting/Receiving devices 10-14 distribute Transmissions 50-54 with Information sections 60-64 to the Transformer 70.

2) Transformer 70 performs a check of the hash function according to the table. If there is correspondence, the sequence continues.

3) If there is no correspondence, the sequence is terminated. An error message is sent to the Information provider/checkout terminal in plain text, along with “Rejected.”

4) Transformer 70 performs an analysis of received Information sections 60-64 in Transmissions 50-54.

5) Check in accordance with a Hash table (Hash functions are prior art and are not included as a function in the invention).

6) Decryption of all Information sections 60-64 in Transmissions 50-54.

7) Deletion of false/misleading Information sections.

8) Assembly/compilation of Information sections 60-64 in Transmissions 50-54 into an anticipated response to the original Information provider/checkout terminal 71.

9) Delivery of query response in plain text to the Information provider/checkout terminal 71 from the Final destination/Check 81, in this case from a bank card company, bank, etc. Credit verification.

10) Standby.

The positive effects of UDP for a predefined user group and private keys (FIG. 3b)

Transmitting devices 10-14 are only open to outgoing traffic, simplex, which eliminates any opportunity for computer viruses to gain entry, which duplex actually facilitates.

Receiving devices 40-44 are pre-set to allow entry only to Transmissions 20-24, i.e. only data that has been packeted in a certain way and contains certain predefined information. This way, software viruses are unable to gain access to the only open port of the 68,000 existing ports exhibited by the Receiving devices 40-44.

Which data port to be opened on a given occasion is determined by a protocol defined and agreed on in advance, i.e. “private keys” that have been exchanged between the users for the servers taking part in the communication.

The ports to be used on a given occasion can also be varied based on a combination with a Transmission time plan, which emerges as a consequence of a table exchanged in advance, which cannot be reconstituted a posteriori, such as a hash table.

Since both Transmitting devices 10-14 and Receiving devices 40-44 use simplex communication, a software virus that gained access, for instance, to Receiving devices 40-44, cannot make contact with a remote criminal mother server, since all outgoing traffic takes place via ports chosen randomly for Transmission, and never simultaneously for receiving, or have been chosen for receiving and are never simultaneously used for Transmission. In this way, devices 10-14 in a Transmission can be Transmitters, and devices 40-44 can be Recipients. In the return reply/verification, 40-44 become the Transmitting devices, and 10-14 become the Receiving devices. This takes place on every occasion, with different functions for opening ports, in order to make it more difficult for software viruses to either enter a device or be able to criminally communicate back to its own server.

There are no flags indicating digital fraternity in the individual Transmissions 20-24, which makes it completely impossible for a wiretapper to find more than possibly one Transmission in the total flow of hundreds of millions of other simultaneous Transmissions passing through the global Internet during any given moment in time. In a utopian example, the level of difficulty for a wiretapper may be said to look as follows: The fact that Transmission 20 in FIG. 3b is associated with Transmission 24 in FIG. 3b is not indicated in any way other than that the code 344 is listed on a position in Transmission 20, e.g. no. 23,566 if it is a Thursday, i.e. the day code 2,341 is in position 32,100, whereas in Transmission 24, it is indicated by position number 97,555, where the code 3F2P is listed, and Thursday there means 5,434 at position 785. This is incomprehensible to anyone other than transformers 70 and 80, which have private keys. Codes of this type have been created in an irreversible tabular form of the type “hash.” Since there are no decryption-facilitating public keys in the Transmissions, the criminal elements have nothing to assist them in decryption.

No requests are sent by Transmitting device 10-14 regarding accessibility, or by 40-44 in the return. These still transmit according to the protocol pre-defined as set forth in the private keys.

A correctly transmitted Original message, which was able to be interpreted by Transformer 80, begins a verification process, which occurs in the same way back to Transformer 70, as in the first Transmission of the Original message from the latter, though in the return Transmission with new Transmissions 50-54, and in these the new Transmission sections 60-64, via completely different paths than those used for the preceding traffic. (see FIG. 5b). No Transmission of any type occurs in the same way as before.

Dividing the verification in the return answer into Transmissions/batches as well in this way is an extraordinary impediment in the way of criminal wiretap and decryption.

Verification according to the invention never takes place using the entire Original message, which is what happens everywhere today. Security is further enhanced in that, for instance, a single row of numbers is used as a final sum or quote, or coded quote, of the Original message. Even the row of numbers is divided into Transmissions/batches in the return response.

If no return response is received from Transformer 80 within a certain period of time, this is interpreted by Transformer 70 as total or partial lack of accessibility; reTransmission then takes place in the same way as before, though along new paths.

The final recipient Transformer 80 knows how many Transmissions will be arriving simply by receiving one Transmission. If the number of Transmissions does not match the criterion, this is not interpreted as accessibility. Instead, all received Transmissions are cancelled, and retransmission from Transformer 70 is awaited.

Every server involved in the communication knows all the other servers that may be involved in the communication process. This means that there may be additional transformers, based on the number of users in the predefined communication group. Every endpoint that is to be a transmitter or recipient of an Original message requires a Transformer and Transmitting/Receiving devices.

### Feasible Modifications of the Invention

In the embodiment of the present invention described above, there is division of information into batches, encryption, separate Transmissions, as well as time staggering between the Transmissions in both directions, i.e. both when the Transmissions are sent from Transformer 70 to Transformer 80 and from Transformer 80 to Transformer 70. However, it is possible within the framework of the present invention that this processing of digital information only takes place upon Transmission from Transformer 70 to Transformer 80, i.e. directly, without using Transmitting/Receiving devices 10-14 or 40-44, with or without the division of the Information packet into Transmissions 20-24 and 50-54, with or without Information sections 30-34 or 60-64. After a response has been received from the Control side/Final destination 81, the desired information about the Information provider can be sent in plain text. This does compromise confidentiality, but it may be enough for certain applications.

It is also not necessary that all the steps to process the digital information described above be performed. In its most simplified form, the invention implies that information is divided into two information sections, and that these are transferred from Transformer 70 to Transformer 80 by means of two separate Transmissions, which do not necessarily need to be internally time-staggered.

### LIST OF DESCRIPTIONS

10-14 Transmitting/Receiving devices for Transmitting/Receiving Information sections;

20-24 Individual, separate Transmissions via the Internet or another communication medium. In this document referred to as Transmissions in aggregate.

30-34 Sections of the Information packet's data, along with false data during Transmission via the Internet or another communication medium. In this document referred to, in summary, as Information sections;

40-44 Transmitting/Receiving devices for Transmitting or Receiving Information sections;

50-54 Individual, separate Transmissions over the Internet or another communication medium. In this document referred to in summary as Transmissions;

60-64 Sections of the Information packet's data as well as false data during the Transmission via the Internet or another communication medium. In this document referred to in summary as Information sections;

65 Broadband connection(s) at the Store end;

66 Broadband connection(s) at the checkout end;

67 Local network;

68-69 Extranet for potential remote connection via a third party;

70 Transformer at the Store end;

71 Querier/Store cashier terminal, etc.;

80 Transformer at the Verification end

81 The checkout end, Final destination for queries of bank cards;

90 Internet or another communication medium;

100 Unauthorized eavesdropper;

101 Unauthorized data eavesdropping connection/conjunction, as well as the ability to infiltrate a system with a software virus in order to affect and/or be able to know in advance the destinations of data processing/Transmissions.

1. Method for the Transmission of digital information, where Transmission takes place from an information-providing entity (71) to a final destination entity (81), where the digital information is transmitted in a first step from the information-providing entity (71) to an initial data communication device (70), which can receive, process and transmit digital information, where the digital information in a subsequent step is sent from the first data communication device (70) to a second data communication device (80), which can receive, process and transmit digital information, and where the digital information in a subsequent step is sent from the second data communication device (80) to the final destination entity (81), where the digital information to be transmitted from the first data communication device (70) to the second data communication device (80) is divided into at least two information sections (30-34), where each information section (30-34) is transmitted from the first data communication device (70) to the second data communication device (80) by means of a separate Transmission (20-24), where the Transmissions (20-24) take place in the form of simplex communication, and where the information in the information sections (30-34) is put together in the second data communication device (80) in order to receive the information coming from the information-providing entity (71), characterized in that verification/return Transmission takes place such that the digital information that comprises verification/return Transmission is sent in an initial step from the final destination entity (81) to the second data communication device (80) and then on from the second data communication device (80) to the first data communication device (70), where the information is divided into at least two information sections (60-64), where every information section (60-64) is transmitted from the second data communication device (80) to the first data communication device (70) by means of a separate Transmission (50-54), where the Transmissions (50-54) take place in the form of simplex communication, and where the information in the information sections (60-64) is assembled in the first data communication entity (70), in order to receive/reveal the information sent by the final destination entity (81).

2. Method according to claim 1, characterized in that the assembly of the information takes place with the help of a hash table.

3. Method according to claim 1, characterized in that at least some of the separate Transmissions (20-24, 50-54) are internally time-staggered.

4. Method according to claim 1, characterized in that at least one of the information sections (30-34, 60-64) contains false information.

5. Method according to claim 1, characterized in that at least one of the information sections (30-34, 60-64) is transmitted via a transmitting/receiving device (10-14 and/or 40-44), which in the sequence of Transmission is located between the first data communication device (70) and the second data communication device (80).

6. Method according to claim 5, characterized in that at least one of the information sections (30-34, 60-64) is transmitted via an additional transmitting/receiving device (40-44 and/or 10-14), which in the sequence of Transmission is located between the first data communication device (70) and the second data communication device (80).

7. Method according to claim 1, characterized in that the Transmission of the information sections (30-34, 60-64) between the transmitting/receiving devices (10-14 och 40-44) takes place via the Internet.

8. Device for the Transmission of digital information, where the device includes an information-providing entity (71) and a final destination entity (81), where an initial data communication device (70), which can receive, process and send digital information, is assigned to the information-providing entity (71), where a second data communication device (80), which can receive, process and send digital information, is assigned to the final destination entity (81), where an initial batch of at least two transmitting/receiving devices (10-14 or 40-44), which in the sequence of Transmission is located between the first data communication device (70) and the second data communication device (80), and where the first batch of sending/receiving devices (10-14 or 40-44) are able to communicate with both data communication devices (70, 80), characterized in-that the first batch of transmitting/receiving devices (10-14 or 40-44) is designed not to perform any processing of the information they transmit or receive.

9. Device according to claim 8, characterized by a second set of at least two transmitting/receiving devices (40-44 or 10-14), which in the sequence of Transmission are installed between the first data communication device (70) and the second data communication device (80), where the second set of transmitting/receiving devices (40-44 or 10-14) can communicate with the first data communication device (70 or 80), and the first set of transmitting/receiving devices (10-14 or 40-44), and where the second set of transmitting/receiving devices (10-14 or 40-44) is designed not to perform any processing of the information they transmit or receive.

10. Device according to claim 8, characterized in that there is a firewall in place between at least one data communication device (70 or 80) and the associated transmitting/receiving devices (10-14 or 40-44).

11. Device according to claim 9, characterized in that there is a firewall in place between at least one data communication device (70 or 80) and the associated transmitting/receiving devices (10-14 or 40-44).
